(19) United States
(12) Patent Application Publication
(10) Pub. No.: US 2014/0062690 A1
(43) Pub. Date: Mar. 6, 2014

(54) Vehicle Warning Device

(71) Applicant: ATBEL TECHNOLOGY CORP., Taipei City (TW)

(72) Inventors: CHIEN-HSIANG CHANG, TAIPEI CITY (TW); CHE-HSING LIAO, TAIPEI CITY (TW)

(73) Assignee: ATBEL TECHNOLOGY CORP., Taipei City (TW)

(21) Appl. No.: 14/014,362

(22) Filed: Aug. 30, 2013

(30) Foreign Application Priority Data
Sep. 5, 2012 (TW) 101217147

(51) Int. Cl. B60Q 1/26

(52) U.S. Cl. CPC B60Q 1/26
USPC 340/471

(57) ABSTRACT

A vehicle warning device includes a lamp holder and a charging base. There are many LEDs at one side of the lamp holder and is a retaining member at the other side. The lamp holder comprises a power switch being outside the lamp holder and electrically connected to the LEDs; a power supply unit being in the lamp holder and electrically connected to the power switch; and a first electric connection unit being in the lamp holder and electrically connected to the power supply unit. The charging base has a charging unit electrically connected to the second electric connection unit, and a second electric connection unit electrically connected to the first electric connection unit. The lamp holder emits light by itself, warning other vehicle drivers or pedestrians. The lamp holder is at a random site outside a vehicle, thereby being featured with high security and high convenience.

### TECHNICAL FIELD OF THE INVENTION

This invention relates to a vehicle warning device and particularly to a vehicle warning device of high security and high convenience.

### DESCRIPTION OF THE PRIOR ART

Thanks to the advancement of technology and the development of vehicles, the distance between urban and rural areas has been much shortened; however, it is followed by increasing traffic accidents every year. From the statistics of the traffic accidents having happened over the years, it is apparent that the traffic accidents were often caused by poor visibility, poor road conditions, quite high driving speed, not maintaining a safe distance and the like, which relatively consumes a lot of social resources and costs; the reason is mainly drivers' inattention or poor visibility. Generally, there is a 70% probability of traffic accidents occurring at night, which accounts for the major cause of all traffic accidents. Visibility is even worse in the rain and thus safety requirements are more stringent on rainy days.

Further, based on road traffic safety rules, if it is not possible to continue driving a running vehicle due to an unpredictable factor, a fault signal light as a warning to rear running cars should be firstly enabled and then a fault sign should be placed behind the car out of order. However, whether it is on general roads, highways, or freeways, especially during daytime, due to the fault signal light or fault sign not being obvious, resulting in the rear car not being able to easily detect the accident ahead, therefore the vehicle out of order would easily get rear-ended by rear vehicles.

A conventional fault sign is formed with only a triangle warning rack and a base; when placed on the road, the height of the sign is close to the road. In the daytime, most drivers do not turn on the lights, so the reflective effect cannot be achieved. Thus, the problem of poor visibility is produced. Further, the risk of accidents happening is caused probably by poor visibility due to poor climate, or by rear vehicle drivers paying little attention to the warning signs on the ground.

In addition, comparing with a conventional light bulbs, a LED has absolute advantages, such as a smaller size, longer service life, lower voltage/current driving, not easily broken, mercury-free, good luminous efficiency, and energy saving. Therefore, the LED is applied very widely in daily life and industries; for example, it is widely applied for various indoor lighting devices, display backlight module, automobile brake light, outdoor information billboard, traffic signs and the like. However, the role of the LED being applied as a light source has been subjected to high expectations and significantly improved, so related energy-saving lamps have gradually emerged and replaced conventional lighting devices.

Thus, the problem of how to breakthrough and resolve the types of defect problems above of conventional fault signs, thereby improving its safety, convenience and economic benefits, as well as combining LED for a more efficient application, is a key focus point which manufacturers and intellectuals should be earnestly trying to resolve and overcome.

Consequently, because of the technical defects described above, the applicant, based on many years of research and experience in the relevant industry has developed the present invention, which may effectively improve the defects described above.

### SUMMARY OF THE INVENTION

The object of this invention is to provide a vehicle warning device that may emit light by itself to warn other vehicle drivers or pedestrians, thereby having high security.

The object of this invention is further to provide a vehicle warning device that may be placed at a random site outside a vehicle, thereby having high convenience.

In order to achieve the objects mentioned above, the vehicle warning device according to this invention comprises a lamp holder and a charging base. One side of the lamp holder is formed with a plurality of light-emitting diodes (LEDs), while the other side of the lamp holder is formed with a retaining member. Further, the lamp holder comprises a power switch, a power supply unit, and a first electric connection unit. The power switch is disposed outside the lamp holder and electrically connected to the LEDs. The power supply unit is disposed in the lamp holder and electrically connected to the power switch. The first electric connection unit is formed in the lamp holder and electrically connected to the power supply unit. The charging base is provided with a charging unit and a second electric connection unit. The charging unit is electrically connected to the second electric connection unit, while the second electric connection unit is electrically connected to the first electric connection unit.

### BRIEF DESCRIPTION OF THE DRAWINGS

FIG. 1 is a 3D exploded view of a vehicle warning device in a first preferred embodiment of this invention;

FIG. 2 is a block diagram of the vehicle warning device in the first preferred embodiment of this invention;

FIG. 3 is a side view of the vehicle warning device in the first preferred embodiment of this invention;

FIG. 4 is a schematic view illustrating the operation state of vehicle warning device in the first preferred embodiment of this invention;

FIG. 5 is a side view of the vehicle warning device in a second preferred embodiment of this invention;

FIG. 6 is a block diagram of the vehicle warning device in the second preferred embodiment of this invention; and

FIG. 7 is a schematic view illustrating the operation state of the vehicle warning device in the second preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

Known from the prior art mentioned above, most fault signs are provided with a reflective design. Thus, when vehicles do not turn on their lights during the day, the faults sign is not able to reflect and warn rear vehicles, or during heavy fog or rain resulting from poor weather and drivers cannot clearly see the fault sign, both situations could cause danger to the parked vehicle. Accordingly, the vehicle warning device is designed for high security and high convenience.

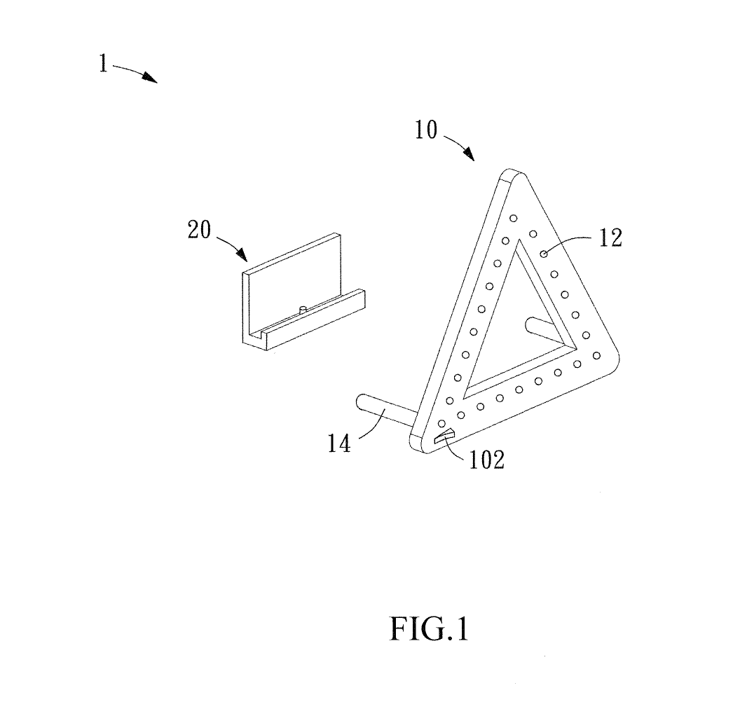

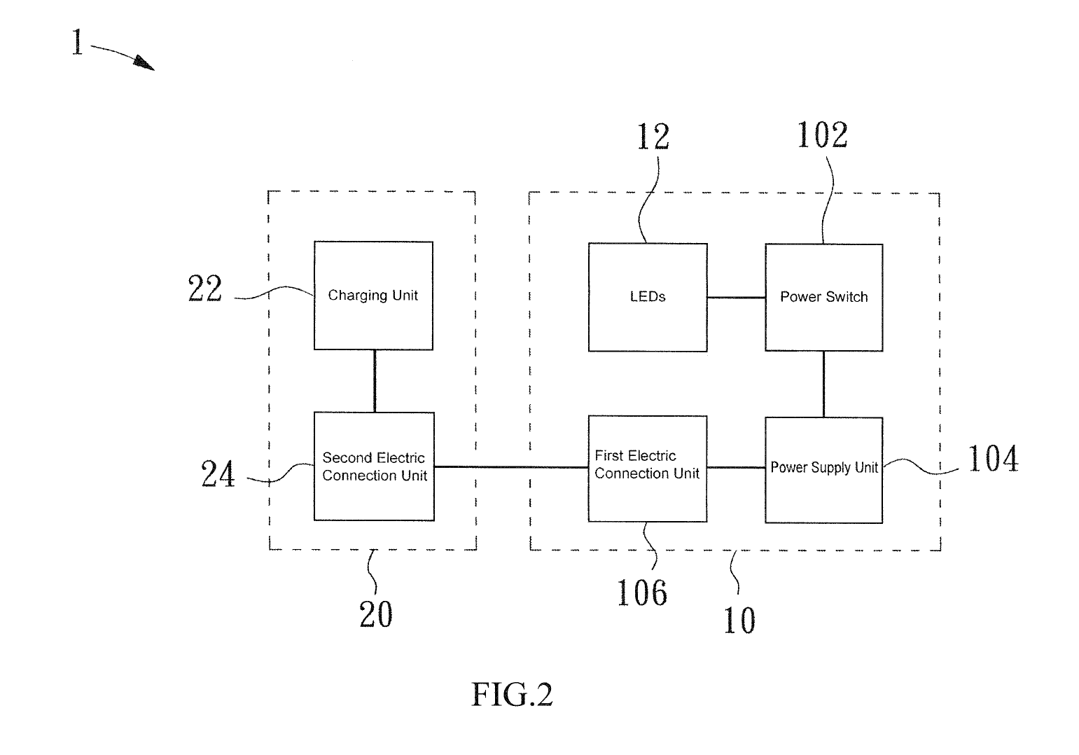

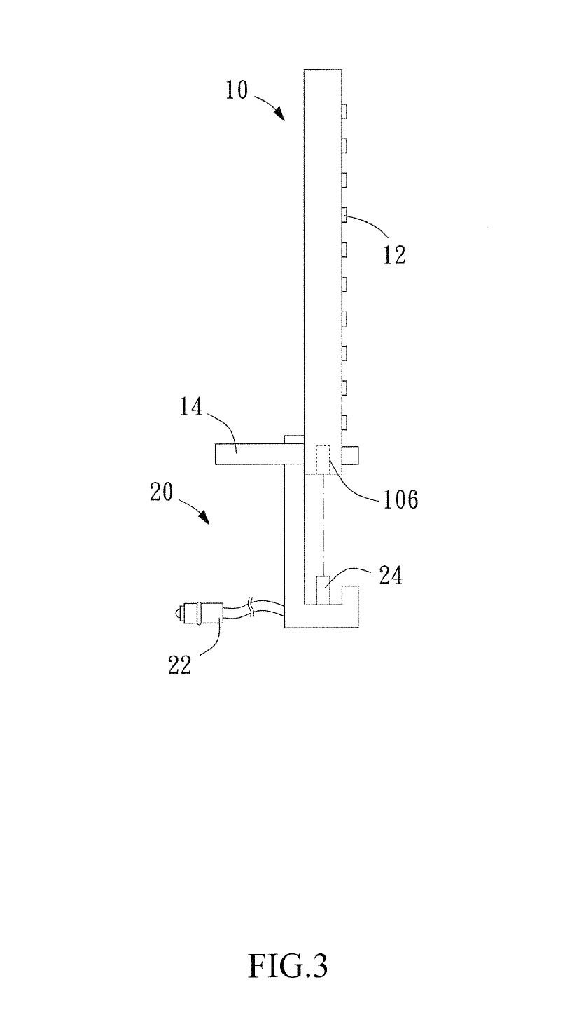

Referring to FIGS. 1 to 3 shown respectively as a 3D exploded view, a block diagram, and a side view that illustrate a vehicle warning device in a first preferred embodiment of this invention. As shown in the figures, the vehicle warning device 1 essentially comprises a lamp holder 10 and a charging base 20. One side of the lamp holder 10 is formed with a plurality of light-emitting diodes (LEDs) 12, while the other side of the lamp holder 10 is formed with a retaining member 14. Further, the lamp holder 10 comprises a power switch 102, a power supply unit 104, and a first electric connection unit 106. The power switch 102 is disposed outside the lamp holder 10 and electrically connected to the LEDs 12 to switch on or off The power supply unit 104 is electrically connected to the power switch 102 so as to supply power to the LEDs 12 through the switch 102. The first electric connection unit 106 is formed outside the lamp holder 10 and electrically connected to the power supply unit 104. The first electric connection unit 106 is used for the power charging of the power supply unit 104.

Further, the charging base 20 is provided with a charging unit 22 and a second electric connection unit 24. The charging unit 22 is electrically connected to the second electric connection unit 24, while the second electric connection unit 24 is electrically connected to the first electric connection unit 106. The charging unit 22 may be a plug and supply wire and thus through the charging unit 22 that is connected to a power source, not shown, such as a power outlet of a car, the power supply unit 104 of the lamp holder 10 is charged. However, in the embodiment, the lamp holder 10 is illustrated as a triangle, while the charging base 20 is illustrated as an L-shaped base. The charging base 20 may be provided only for charging the lamp holder 10. The lamp holder 10 and the charging base 20 are not limited to a particular shape. Further, the charging base 20 may be loaded with the lamp holder 10 to facilitate charging the lamp holder 10.

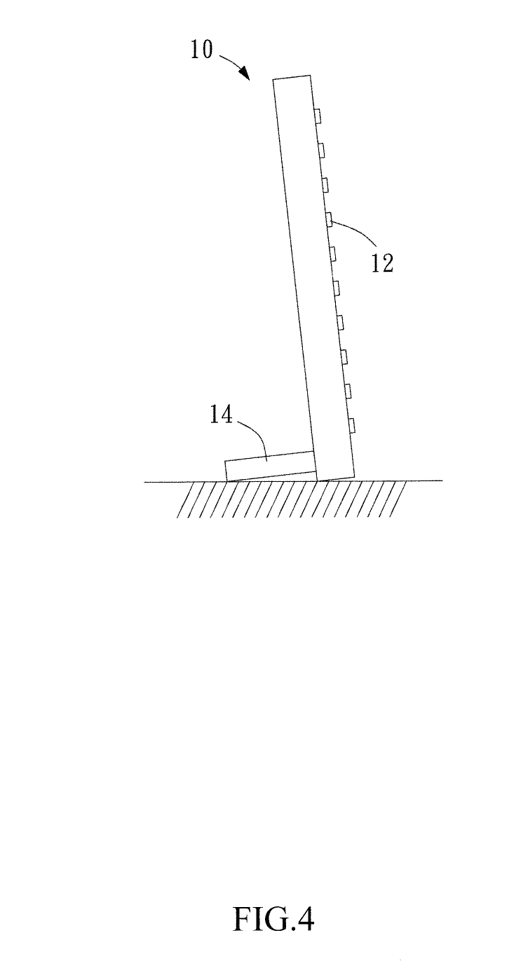

Generally, when the vehicle warning device 1 is not used, the lamp holder 10 may be put aside in a vehicle and the first electric connection unit 106 is made to connect to the second electric connection unit 24 of the charging base 20, thereby allowing the power supply unit 104 to store power. For using the vehicle warning device 1, the first electric connection unit 106 may be detached from the second electric connection unit 24, and then the retaining member 14 is used to mount the lamp holder 10 onto a random site outside the vehicle. For example, when a vehicle malfunctions on a general road or a highway, the retaining member 14, which may be two support stands and is arranged at one side of the lamp holder 10, is vertical to the lamp holder 10 for making the lamp holder 10 stand, as shown in FIG. 4. The LEDs 12 that is driven with the power supplied by the power supply unit 104 may emit light for warning the rear vehicle drivers. Further, when the vehicle is only parked at the side of the road and needs to give a warning to other vehicle drivers or pedestrians, the retaining member 14 may be a magnetic member or a clamping member (not shown) that is attracted or clamped to a portion outside the vehicle.

However, known from the prior art mentioned above, most fault signs are provided with the reflective design. Thus, when rear vehicles do not turn on their lights during the day and is not able to reflect the sign, or during heavy fog or rain resulting from poor weather and drivers cannot clearly see the fault sign, both situations could cause danger to the parked vehicle of being rear-ended. In this invention that solves the defects mentioned above, the LEDs 12 on the lamp holder 10 may emit light by itself to warn the rear vehicle drivers, thus enhancing the warning effect and thereby being featured with high security. And compared with a conventional light bulb, the LED 12 consumes less energy, allowing the lamp holder 10 to emit warning lights for a longer period of time. Further, the lamp holder 10, when being used, may be set in the vehicle or at a random site outside the vehicle to facilitate user operation; the lamp holder 10, when not being used, may be placed in the vehicle and connected to the charging base 20 to charge the power supply unit 104 with power for next time operation, thereby being featured with high convenience.

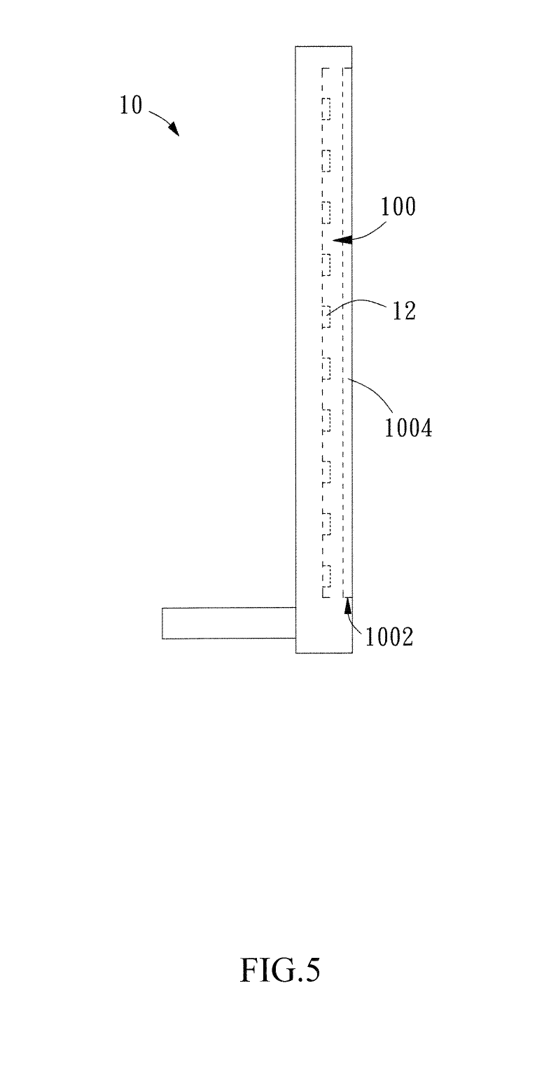

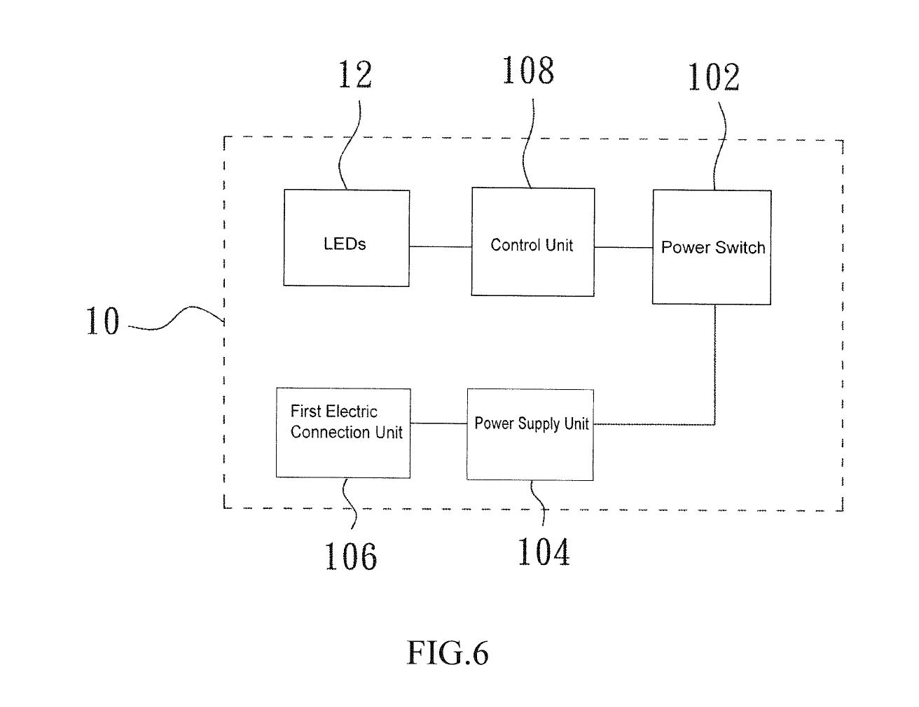

Referring to FIGS. 5 and 6 shown as a side view and a block diagram that illustrate the vehicle warning device in a second preferred embodiment of this invention. One side of the lamp holder 10 further comprises a capacity set slot 100. The LEDs 12 are mounted onto the bottom side of the capacity set slot 100. A rabbet 1002 of the capacity set slot 100 is formed with a cover 1004. The cover 1004 may make the light of LEDs 12 reflect to form a source of light for widening the area of lighting. Further, the lamp holder 10 may comprises a control unit 108. The control unit 108 is electrically connected to a node between the LED 12 and the power switch 102 so as to control the LED 12 to blink for the function of warning.

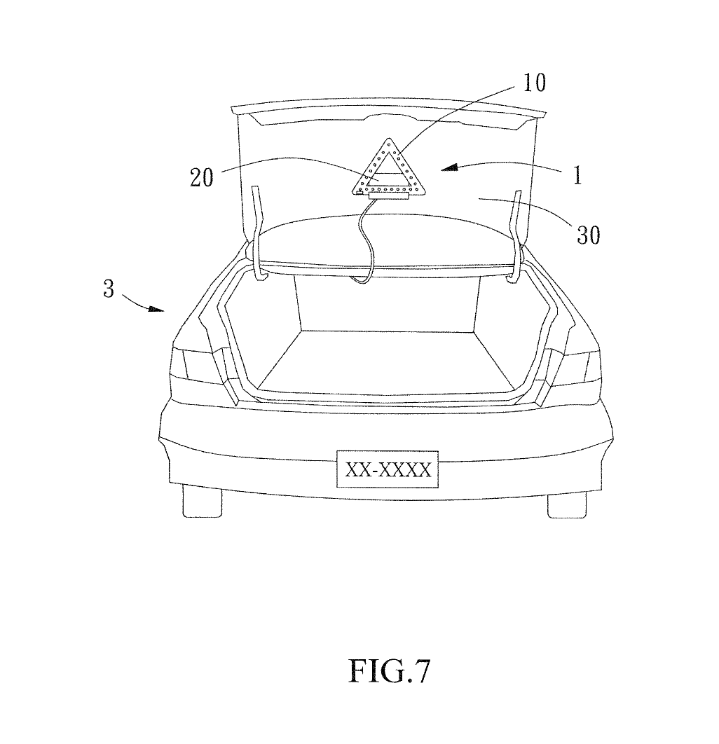

Referring to FIG. 7 shown as a schematic view illustrating the operation state of vehicle warning device in the second preferred embodiment of this invention. The charging base 20 may be set at a side of the road or in a vehicle 3, such as an inner side of the luggage compartment lid 30. The lamp holder 10 may be set on the charging base 20 for simultaneous charging and operation. To use the device, merely the luggage compartment lid 30 is firstly opened and then the power switch 102 is switched on, as shown in FIG. 1, which may thereby warn the rear vehicle drivers to prevent collision accidents; thus, the device is of high security.

Thanks to the vehicle warning device according to this invention that consists essentially of the members mentioned above, the lamp holder may be set in the vehicle or at a random site outside the vehicle to warn rear and surrounding vehicle drivers and pedestrians, thereby the vehicle warning device being featured with extremely high convenience. Further, for prevention of low visibility, the LEDs 12 on the lamp holder 10 may emit light by itself to warn the rear vehicle drivers, thereby being featured with high security.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

I claim:

1. A vehicle warning device, comprising:
a lamp holder, one side of which is formed with a plurality of light-emitting diodes (LEDs) and the other side of which is formed with a retaining member, comprising:
a power switch, being disposed outside the lamp holder and electrically connected to the LEDs;
a power supply unit, being disposed in the lamp holder and electrically connected to the power switch; and
a first electric connection unit, being formed in the lamp holder and electrically connected to the power supply unit;
a charging base being provided with a charging unit and a second electric connection unit, the charging unit being electrically connected to the second electric connection unit and the second electric connection unit being electrically connected to the first electric connection unit.

2. The vehicle warning device of claim 1, wherein the vehicle warning device further comprises a control unit that is electrically connected to a node between the LED and the power switch.

3. The vehicle warning device of claim 1, wherein one side of the lamp holder further comprises a capacity set slot and the LEDs are mounted onto the bottom side of the capacity set slot.

4. The vehicle warning device of claim 3, wherein a rabbet of the capacity set slot is formed with a cover.

5. The vehicle warning device of claim 1, wherein the lamp holder is a triangle.

6. The vehicle warning device of claim 1, wherein the retaining member is a magnetic member.

7. The vehicle warning device of claim 1, wherein the retaining member is provided with two support stands that are arranged at one side of the lamp holder.

8. The vehicle warning device of claim 1, wherein the retaining member is a clamping member.
